(19) United States
(12) Patent Application Publication
(10) Pub. No.: US 2026/0112107 A1
(43) Pub. Date: Apr. 23, 2026

(54) LLM GENERATED METADATA FOR IMMERSIVE VIRTUAL LOCATION OPTIMIZATION

(71) Applicant: SAP SE, Walldorf (DE)

(72) Inventors: Oliver SCHIRMER, Heidelberg (DE); Benedikt KUDER, Karlsruhe (DE)

(21) Appl. No.: 18/921,354

(22) Filed: Oct. 21, 2024

(51) Int. Cl. G06T 17/00

(52) U.S. Cl. CPC G06T 17/00

(57) ABSTRACT

A system associated with an immersive virtual location framework may receive, from a creator, an immersive virtual location request (e.g., including requested furniture within a room and relationships between furniture). The system may automatically create a request prompt based on the immersive virtual location request and transmit the request prompt to a generative AI LLM. Structured data, including metadata and information about the requested elements, can then be received from the LLM and an initial immersive virtual location is generated. The system may execute an optimization algorithm (e.g., simulated annealing), configured using cost functions and constraints based on the structured data, on the initial immersive virtual location to generate an optimized immersive virtual location. In some embodiments, a three-dimensional scene is created based on the optimized immersive virtual location and it is arranged for a user to interact with the scene.

### BACKGROUND

An enterprise may want to create an immersive virtual location (e.g., a three-dimensional interactive environment) for a number of reasons. For example, a business might want to create an immersive virtual location to train or evaluate employees. Manually creating such an immersive virtual location, however, can be a time consuming and expensive task, especially when there are a substantial number of locations, characters, and use cases (e.g., various objects and characters may need to be generated and located within the environment, story lines and scripts may need to be generated, etc.). Moreover, existing methods for creating these environments may not be sufficiently immersive to facilitate effective learning and recall or to provide a realistic context for training or simulation. In addition, there is a need for a system that allows for the automated and repeatable creation of these environments (tailored according to the specific requirements of the scenario at hand). Existing solutions may be overly generic, not customizable, or inefficient in terms of the time and resources required for creation.

Moreover, the development, implementation, and maintenance of high-quality, immersive virtual environments can be expensive and resource intensive. There is a need for a more cost-effective solution that still delivers high-quality results. Further, existing solutions fail to generate realistically furnished rooms in terms of functionality, aesthetics, positioning, and other common interior design principles. This lack of realism impedes immersion, making it difficult to achieve effective learning, recall, and realistic training or simulation experiences.

It would therefore be desirable to provide an improved immersive virtual location framework in a secure, automatic, and efficient manner.

### SUMMARY

According to some embodiments, methods and systems associated with an immersive virtual location framework may receive, from a creator, an immersive virtual location request including a set of requested elements and relationships between the requested elements (e.g., requested furniture within a room and relationships between furniture). The system may automatically create a request prompt based on the immersive virtual location request and transmit the request prompt to a generative artificial intelligence Large Language Model (“LLM”). Structured data, including metadata and information about the requested elements, can then be received from the LLM and an initial immersive virtual location is generated. The system may execute an optimization algorithm (e.g., simulated annealing), configured using cost functions and constraints based on the structured data, on the initial immersive virtual location, including positioning of requested elements within the initial immersive virtual location, to generate an optimized immersive virtual location. In some embodiments, a three-dimensional scene is created based on the optimized immersive virtual location and it can then be arranged for a user to interact with the scene.

Some embodiments comprise: means for receiving, by an immersive virtual location framework from a creator, an immersive virtual location request including a set of requested elements and relationships between the requested elements; means for automatically creating a request prompt based on the immersive virtual location request; means for transmitting the request prompt to a generative artificial intelligence Large Language Model (“LLM”); means for receiving, from the LLM, structured data including metadata and information about the requested elements; means for generating an initial immersive virtual location; and means for executing an optimization algorithm, configured using cost functions and constraints based on the structured data, on the initial immersive virtual location, including positioning of requested elements within the initial immersive virtual location, to generate an optimized immersive virtual location.

Some technical advantages of some embodiments disclosed herein are improved systems and methods to provide an immersive virtual location framework in a secure, automatic, and efficient manner.

### BRIEF DESCRIPTION OF THE DRAWINGS

FIG. 1 is a high-level immersive virtual location framework architecture in accordance with some embodiments.

FIG. 2 is a method according to some embodiments.

FIG. 3 is an overall workflow in accordance with some embodiments.

FIG. 4 is a three-dimensional scene method according to some embodiments.

FIG. 5 is an immersive environment in accordance with some embodiments.

FIG. 6 is an example of a prompt according to some embodiments.

FIG. 7 is another overall workflow in accordance with some embodiments.

FIG. 8 is a simulated annealing method according to some embodiments.

FIG. 9 is an example associated with a set of optimization algorithms in accordance with some embodiments.

FIG. 10 illustrates some examples of use cases according to some embodiments.

FIG. 11 is an apparatus or platform according to some embodiments.

FIG. 12 is a portion of an immersive virtual location database in accordance with some embodiments.

FIG. 13 illustrates a tablet computer immersive virtual location display according to some embodiments.

FIG. 14 is an immersive virtual location framework operator or administrator display in accordance with some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

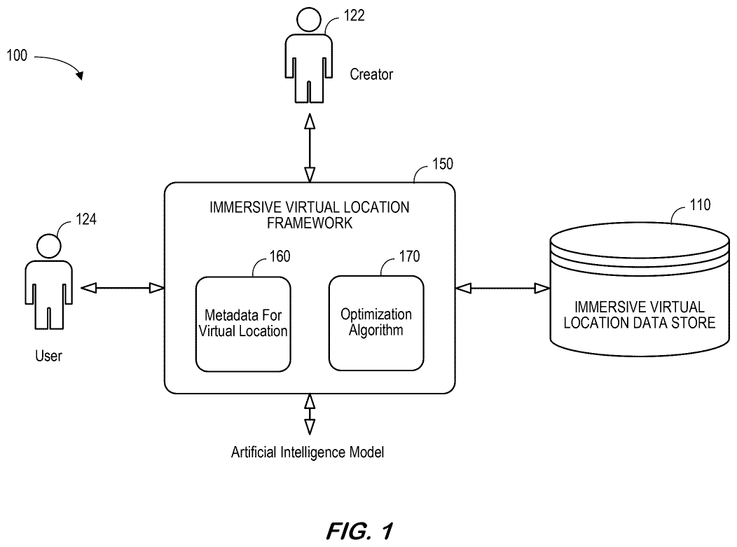

FIG. 1 is a high-level block diagram of one example of an immersive virtual location framework 100 architecture according to some embodiments. In particular, an immersive virtual location framework 150 may exchange information associated with three-dimensional scenes (e.g., each three-dimensional scene being associated with an immersive virtual location) with an immersive virtual location data store 110. The immersive virtual location framework 150 may use metadata for a virtual location 160 and an optimization algorithm 170 in combination with an artificial intelligence model to create or modify an immersive experience in response to a request from a creator 122. The experience may then be provided to one or more users 124 (e.g., to train or evaluate employees). According to some embodiments, a remote operator or administrator device may be used to configure or otherwise adjust the framework 100.

As used herein, devices, including those associated with the framework 100 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The immersive virtual location framework 150 may store information into and/or retrieve information from various data stores (e.g., the immersive virtual location data store 110), which may be locally stored or reside remote from the immersive virtual location framework 150. Although a single immersive virtual location framework 150 is shown in FIG. 1, any number of such devices may be included. Moreover, various devices described herein might be combined according to embodiments of the present invention. For example, in some embodiments, the immersive virtual location data store 110 and the immersive virtual location framework 150 might comprise a single apparatus. The framework 100 functions may be performed by a constellation of networked apparatuses, such as in a distributed processing or cloud-based architecture. In some cases, the immersive virtual location framework 150 may process information associated with a number of different enterprises.

An enterprise may access the framework 100 via a remote device (e.g., a Personal Computer (“PC”), tablet, or smartphone) to view information about and/or manage operational information in accordance with any of the embodiments described herein. In some cases, an interactive Graphical User Interface (“GUI”) display may let an operator or administrator define and/or adjust certain parameters via a remote device (e.g., to specify how the framework 150 connects with an enterprise computing environment infrastructure, to edit scenes, etc.) and/or provide or receive automatically generated recommendations, alerts, summaries, or results associated with the framework 100.

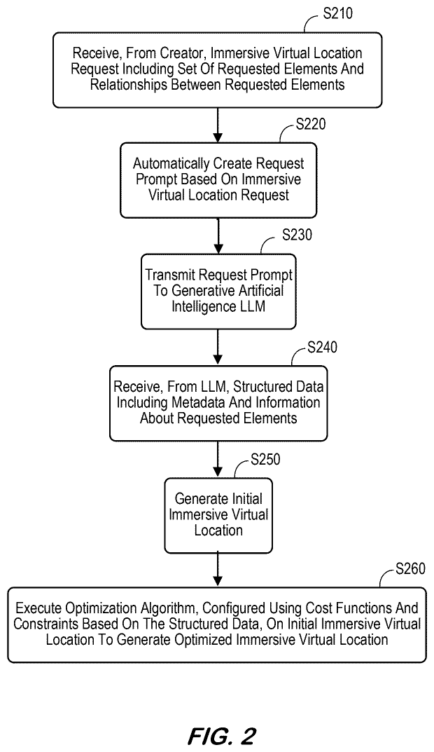

FIG. 2 is a method that might be performed by some or all of the elements of the framework 100 described with respect to FIG. 1. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, the system may receive, from a creator, an immersive virtual location request (e.g., including a set of requested elements and relationships between the requested elements). In some embodiments, the immersive virtual location request includes an environment description of a virtual location. As used herein, the phrase “virtual location” may refer to an interactive, three-dimensional environment that may be experienced by a user (e.g., in connection with a computer display, a virtual reality device, augmented reality glasses, etc.). According to some embodiments, the immersive virtual location request includes information about a room description, a physics description (e.g., how objects should move or interact), a style suggestion (e.g., an office or school environment), a user goal (e.g., making a sale or evaluating a medical condition), a character in the virtual location, etc. The immersive virtual location request received from the creator might be associated with, for example, a text request, an audio request (e.g., a spoken description of a location), an image request (e.g., a location that looks similar to this picture), a video request (e.g., the character should move in this fashion), etc.

At S220, the system may automatically create a request prompt based on the immersive virtual location request. The request prompt might be based on, for example, an environment description or information inferred from a scenario (e.g., “a location suitable where a doctor will talk with a patient”). According to some embodiments, the immersive virtual location framework dynamically refines the request prompt via interactions with the creator.

At S230, the request prompt is transmitted to a generative artificial intelligence Large Language Model (“LLM”). Structured data, including metadata and information about the requested elements, is then received from the LLM. In some embodiments, the generative artificial intelligence model is “multimodal.” As used herein, the term “multimodal” may refer to a type of deep learning using a combination of various modalities of data (such as text, audio, or images) to create a robust model of real-world phenomena. As used herein, the phrase “generative artificial intelligence” may refer to models that capable of generating text, images, videos, or other data by learning patterns and structure of the input training data and the generating new data that has similar characteristics. Moreover, the multimodal generative artificial intelligence model might comprise a computational model able to achieve general-purpose language generation and other natural language processing tasks such as an LLM. Some examples of LLMs include OPENAI™ CHATGPT® 782 model, a GOOGLE™ GEMINI® 784 model, an ANTHROPIC™ CLAUDE OPUS® 786 model, etc.

At S250, the system generates an initial immersive virtual location. An optimization algorithm, configured using cost functions and constraints based on the structured data, is executed on the initial immersive virtual location, including positioning of requested elements within the initial immersive virtual location, at S260 to generate an optimized immersive virtual location. Note that additional user-based constrains may also be possible (e.g., a user may fix the position of a table with respect to a specific position and the optimization algorithm tries to find the optimal placement for all of the other furniture). This may let a visual editor refine generated scenes and/or set additional constraints. In this way, embodiments may help create immersive virtual environments that can be used for various scenarios such as training and simulation. Existing methods for creating these environments may not be sufficiently immersive to facilitate effective learning and recall, or to provide a realistic context for training or simulation. Moreover, the system may allow for the automated and repeatable creation of these environments, tailored according to the specific requirements of the scenario at hand. Note that existing solutions may be overly generic, not customizable, or inefficient in terms of the time and resources required for creation. Embodiments may leverage multiple Generative Artificial Intelligence (“GenAI”) models to create immersive, customizable, and shareable virtual environments.

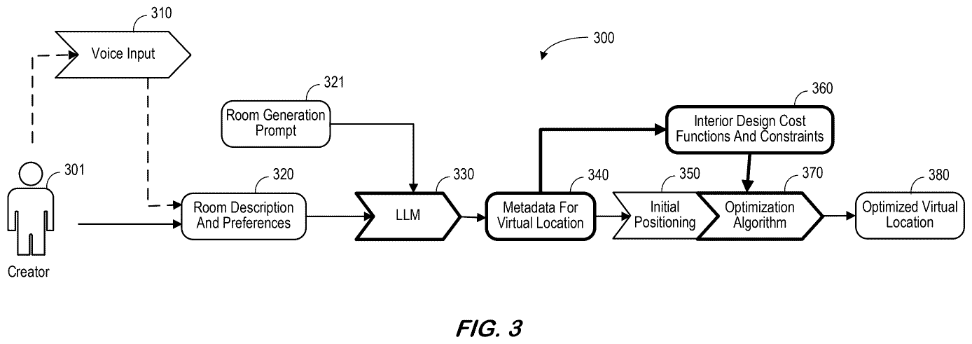

Some embodiments address the problem of creating immersive and realistic virtual environments by utilizing a combination of LLMs and optimization techniques (e.g., simulated annealing). For example, FIG. 3 is an overall workflow 300 in accordance with some embodiments. A creator 301 provides a room description and preferences 320 (e.g., “a modern doctor's office with an X-ray machine” or “a medium size classroom”). In some embodiments, the room description and preferences 320 may be provided via a voice input 310. The room description and preferences 320 and a room generation prompt 321 may then be sent to an LLM 330 and used to create an immersive virtual environment. Embodiments may begin with the optimization of a specific prompt using prompt engineering (e.g., to structure an instruction that can be interpreted and understood by a generative artificial intelligence model). The prompt may be dynamic and based on user input (text or voice), which can include room or scene descriptions, style hints, and additional wishes.

The LLM 330 generates structured data (e.g., a JSON file) that focuses on less complex tasks, which are important for the final optimization. While LLMs fall short when it comes to spatial reasoning in complex situations, they are capable of handling specific, less complex tasks to generate the necessary metadata (e.g., single-item details, functional groups, points of emphasis or pairwise constraints). The structured data includes metadata for the virtual location 340. This structured data is then parsed, and objects are placed in the virtual room creating an initial positioning 350. The structured metadata for the virtual location 340 also includes interior design cost functions and constraints 360. The initial positioning 350 of the objects is then used by an optimization algorithm 370, configured with the cost functions and constraints 360, to help ensure a realistic and aesthetically pleasing interior design. The result of the optimization algorithm 370 is an optimized virtual location 380. The optimized virtual location 380 can then be rendered into an immersive 3D scene, such as by using experience engines (e.g., the UNREAL ENGINE®), resulting in a high-quality, realistic virtual environment. This approach not only improves cost-effectiveness and repeatability, but also allows for customization that is tailored to specific requirements (enhancing the overall immersive experience for training, simulation, and other applications).

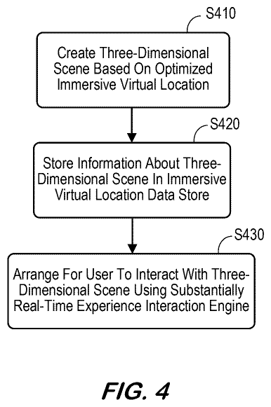

FIG. 4 is a three-dimensional scene method according to some embodiments. At S410, the system creates a three-dimensional scene based on the optimized immersive virtual location. Note that the immersive virtual location might include a room, and the requested elements may comprise furniture within the room. In this case, the relationships between the requested elements may represent relationships between furniture within the room. The result of the optimization algorithm may produce a three-dimensional scene of a realistically furnished room in terms of functionality, aesthetics, positioning, an interior design principle, etc. As used herein, the phrase “interior design principle” may be associated with the art and science of enhancing the interior of a building to achieve a healthier and more aesthetically pleasing environment for the people using the space. An interior design principle might be associated with a style (e.g., art deco, modern art, feng shui, etc.) and or functionality (e.g., a commercial design, a retail environment, a corporate environment, healthcare, recreation, government offices, schools and universities, religious facilities, industrial facilities, event design, etc.).

Information about the three-dimensional scene is then stored at S420 in an immersive virtual location data store. The stored information about the three-dimensional scene might include, for example, a Java Script Object Notation (“JSON”) file containing virtual environment locations, virtual environment dimensions, local or global constraints of objects, specific object properties, information that cannot be derived from an asset name, virtual environment mesh references, etc. Embodiments may then arrange for a user to interact with the three-dimensional scene using a substantially real-time experience interaction engine at S430. The immersive virtual location framework may be, according to some embodiments associated with a training use case, an educational use case, a public speaking use case, a sales simulation use case, an entertainment use case, etc. The information about the three-dimensional scene in the immersive virtual location data store might be sharable with a plurality of creators. Similarly, the information about the three-dimensional scene in the immersive virtual location data store might be sharable with a plurality of users.

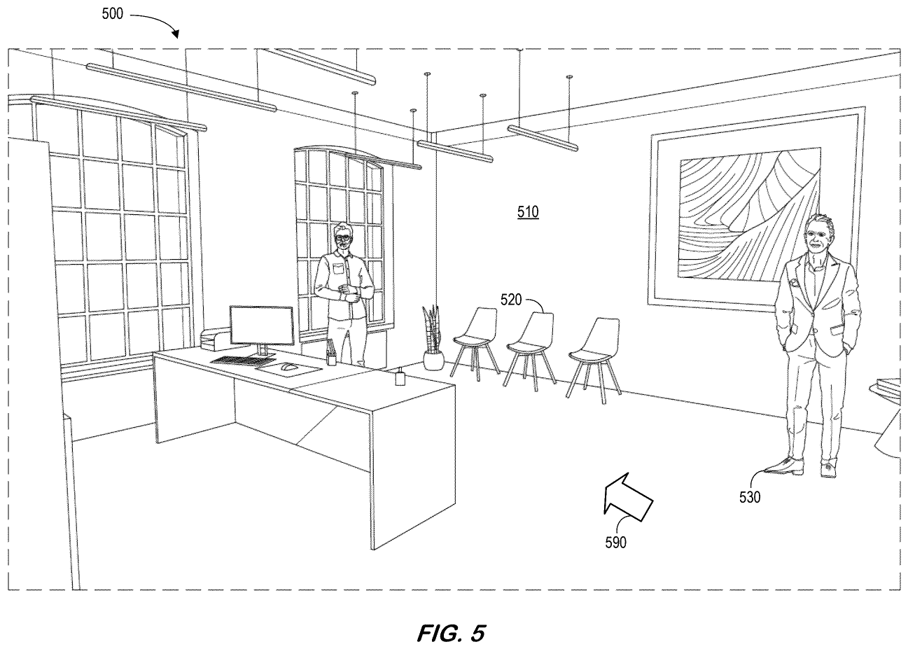

FIG. 5 is an immersive environment 500 in accordance with some embodiments. The environment 500 might include a three-dimensional room 510 with furniture 520 and virtual agents or characters 530 that a user can interact with (e.g., via voice, eye movement, a touchscreen or computer mouse pointer 590, etc.). According to some embodiments, the optimization algorithm may help ensure that the furniture 520 is logically and coherently placed (e.g., chairs may be directed to a table, there is sufficient space to comfortably move around, etc.).

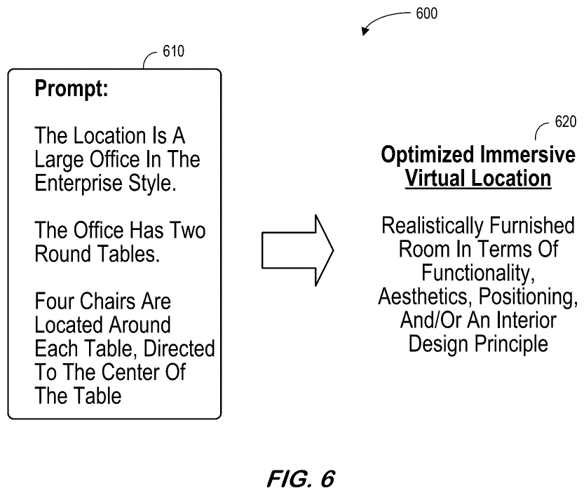

FIG. 6 is an example 600 of a prompt 610 generator by a creator according to some embodiments. The creator may use the prompt 610 to define the basic elements of the room, the style of the room, etc. According to some embodiments, an enterprise may be associated with one or more particular styles which can be referenced in the prompt 610. An optimized immersive virtual location 620 is then generated in response to the prompt 610. If the creator is not satisfied with some aspect of the location 620, adaptations and changes may be facilitated.

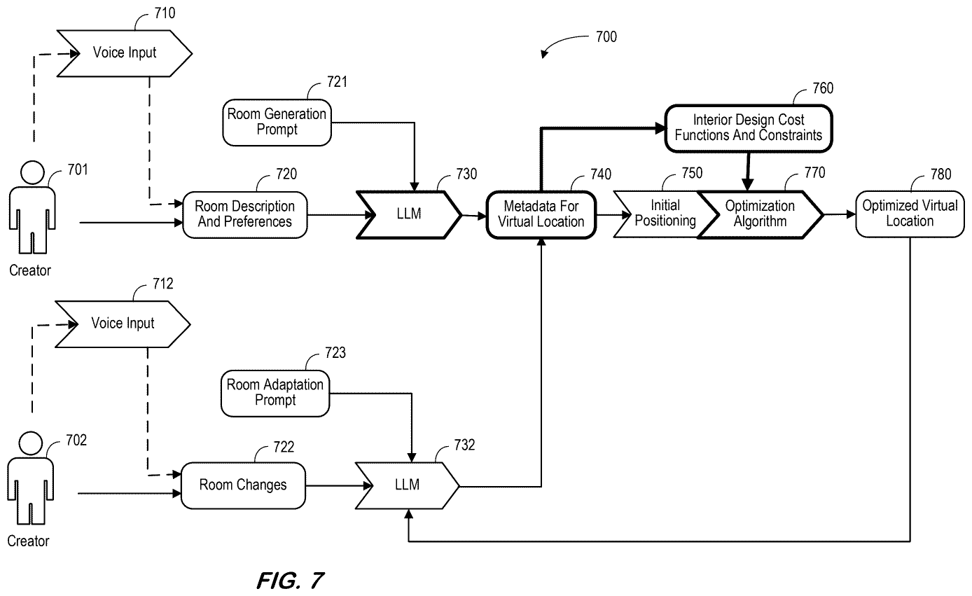

For example, FIG. 7 is an overall workflow 700 to facilitate room adaptations and changes in accordance with some embodiments. As before, a creator 701 provides a room description and preferences 720 which may be provided via a voice input 710. The room description and preferences 720 and a room generation prompt 721 are sent to an LLM 730 and used to create an immersive virtual environment. The LLM 730 generates structured data that includes metadata for the virtual location 740. This structured data is then parsed, and objects are placed in the virtual room creating an initial positioning 750. The structured metadata for the virtual location 740 also includes interior design cost functions and constraints 760. The initial positioning 750 of the objects is then used by an optimization algorithm 770, configured with the cost functions and constraints 760, to help ensure a realistic and aesthetically pleasing interior design. The result of the optimization algorithm 770 is an optimized virtual location 780. This optimized virtual location 780 can then be rendered into an immersive 3D scene using experience engines. A creator 702 may review the generated room and provide room changes 722 which may be provided via a voice input 712. The room changes 722 and a room adaptation prompt 723 are sent to another LLM 732 and used to adjust an immersive virtual environment. This LLM 732 generates updated structured data that includes revised metadata for the virtual location 740. Note that using an LLM is only one way to set constraints for a scene. In some cases, a creator (especially in the context of applying changes to a generated room) might prefer to use a visual 3D editor to adjust positioning of furniture.

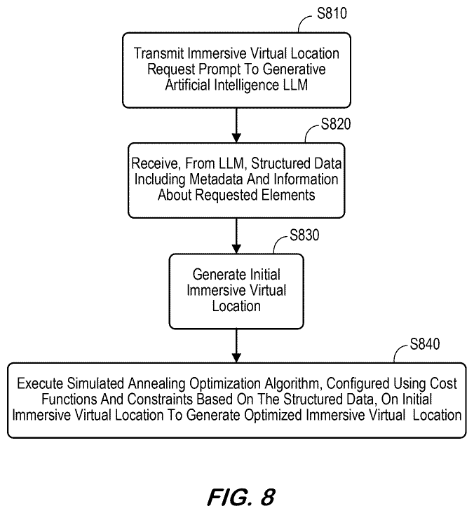

FIG. 8 is a simulated annealing method according to some embodiments. At S810, an immersive virtual location request prompt is transmitted to a generative artificial intelligence LLM. Structured data, including metadata and information about the requested elements, is then received from the LLM at S820. At S830, the system generates an initial immersive virtual location. A simulated annealing optimization algorithm, configured using cost functions and constraints based on the structured data, is executed on the initial immersive virtual location, including positioning of requested elements within the initial immersive virtual location (e.g., positioning information about furniture within the immersive virtual location), at S840 to generate an optimized immersive virtual location. As used herein, the phrase “simulated annealing” may refer to any probabilistic optimization technique for approximating the global optimum of a given function. Specifically, it may be a metaheuristic (higher-level procedure designed to find, generate, tune, or select a partial search algorithm to provide a sufficiently good solution to an optimization problem in a large search space.

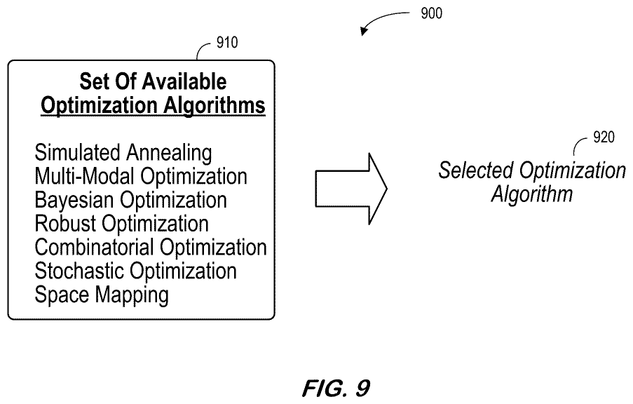

In some cases, embodiments might also utilize optimization algorithms other than simulated annealing. For example, FIG. 9 is an example 900 associated with a set of available optimization algorithms 910 in accordance with some embodiments. The set of available optimization algorithms 910 might include, for example, simulated annealing optimization, multi-modal optimization, Bayesian optimization, robust optimization, combinational optimization, stochastic optimization, space mapping techniques, etc. One or more algorithms may then be selected (e.g., automatically or manually by a creator) resulting in a selected optimization algorithm 920 that can be used in accordance with any of the embodiments described herein.

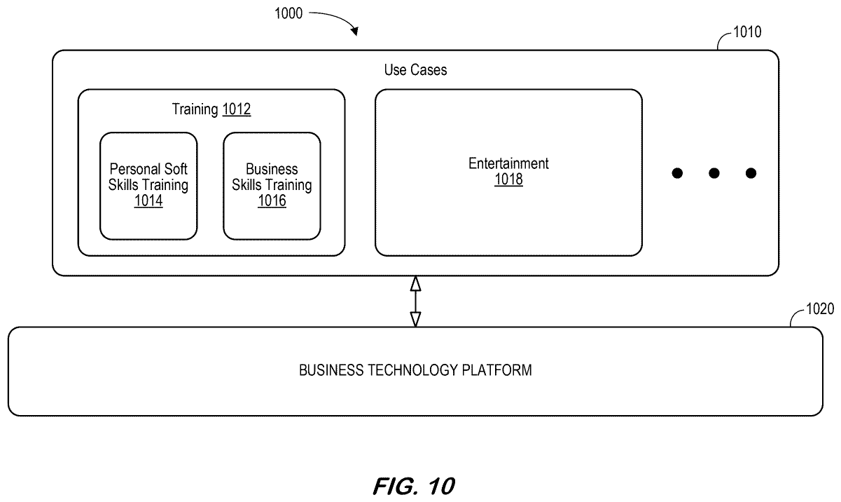

FIG. 10 is an illustration 1000 of some examples of use cases 1010 according to some embodiments. The use cases 1010 may interact with a business technology platform 1020 to extend and personalize applications, integrate and connect landscapes, and/or unleash business users to connect processes and experiences, make decisions with confidence, and drive business innovation. The use cases 1010 might be associated with, for example, training 1012 and entertainment 1018 (e.g., to create movies or video games), etc. The training 1012 might include, for example, personal soft skills training 1014 (e.g., becoming comfortable with public speaking, learning a new hobby, creating a video message for a special occasion, etc.) and/or business skills training 1016 (e.g., sales simulation, learning programming, improving decision making, talking with employees, learning a new role, an enterprise employee onboarding process, etc.).

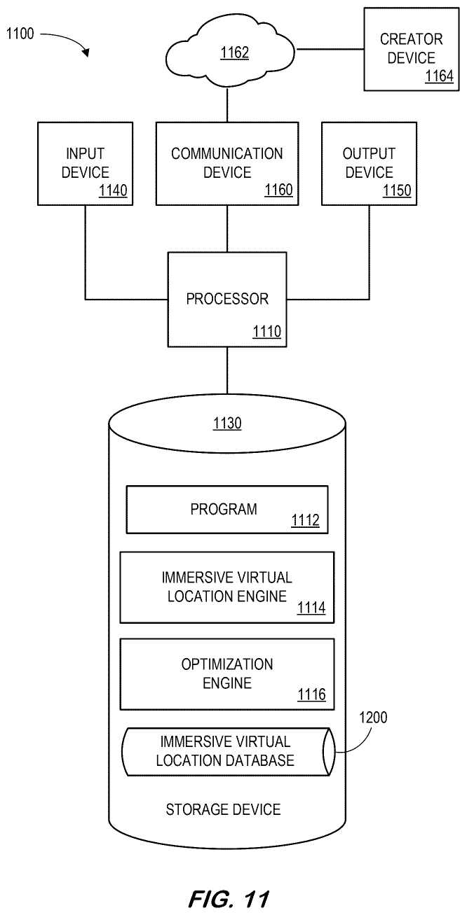

Note that the embodiments described herein may be implemented using any number of different hardware configurations. For example, FIG. 11 is a block diagram of an apparatus or platform 1100 that may be, for example, associated with the framework 100 of FIG. 1 (and/or any other system described herein). The platform 1100 comprises a processor 1110, such as one or more commercially available Central Processing Units (“CPUs”) in the form of one-chip microprocessors, coupled to a communication device 1160 configured to communicate via a communication network 1162. The communication device 1160 may be used to communicate, for example, with one or more creator devices 1164 via a distributed computer network 1162. The platform 1100 further includes an input device 1140 (e.g., a computer mouse and/or keyboard to input location information, object descriptions, etc.) and/an output device 1150 (e.g., a computer monitor to render a display, transmit recommendations, charts, alerts, and/or reports about immersive virtual location results, etc.).

The processor 1110 also communicates with a storage device 1130. The storage device 1130 may comprise any appropriate information storage device, including combinations of magnetic storage devices (e.g., a hard disk drive), optical storage devices, mobile telephones, and/or semiconductor memory devices. The storage device 1130 stores a program 1112, immersive virtual location engine 1114, and/or optimization engine 1116 for controlling the processor 1110. The processor 1110 performs instructions of the programs 1112, 1114, 1116 and thereby operates in accordance with any of the embodiments described herein. For example, the processor 1110 may receive, from a creator, an immersive virtual location request including a set of requested elements and relationships between the requested elements (e.g., requested furniture within a room and relationships between furniture). The processor 1110 may automatically create a request prompt based on the immersive virtual location request and transmit the request prompt to a generative artificial intelligence LLM. Structured data, including metadata and information about the requested elements, can then be received from the LLM and an initial immersive virtual location is generated. The processor 1110 may execute an optimization algorithm (e.g., simulated annealing), configured using cost functions and constraints based on the structured data, on the initial immersive virtual location, including positioning of requested elements within the initial immersive virtual location, to generate an optimized immersive virtual location. In some embodiments, a three-dimensional scene is created based on the optimized immersive virtual location and it can then be arranged for a user to interact with the scene.

The programs 1112, 1114, 1116 may be stored in a compressed, uncompiled and/or encrypted format. The programs 1112, 1114, 1116 may furthermore include other program elements, such as an operating system, clipboard application, a database management system, and/or device drivers used by the processor 1110 to interface with peripheral devices.

As used herein, information may be “received” by or “transmitted” to, for example: (i) the platform 1100 from another device; or (ii) a software application or module within the platform 1100 from another software application, module, or any other source.

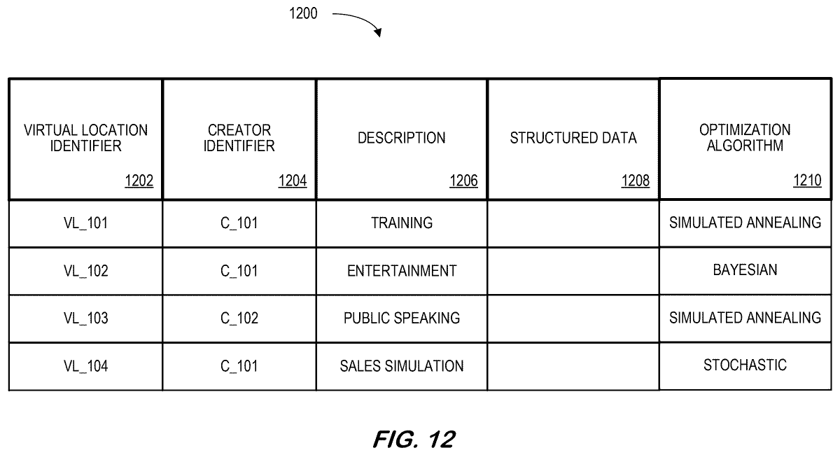

In some embodiments (such as the one shown in FIG. 11), the storage device 1130 further stores an immersive virtual location database 1200. An example of a database that may be used in connection with the platform 1100 will now be described in detail with respect to FIG. 12. Note that the database described herein is only one example, and additional and/or different information may be stored therein. Moreover, various databases might be split or combined in accordance with any of the embodiments described herein.

Referring to FIG. 12, a table is shown that represents the immersive virtual location database 1200 that may be stored at the platform 1100 according to some embodiments. The table may include, for example, entries identifying scenes that may be experienced. The table may also define fields 1202, 1204, 1206, 1208, 1210 for each of the entries. The fields 1202, 1204, 1206, 1208, 1210 may, according to some embodiments, specify: a virtual location identifier 1202, a creator identifier 1204, a description 1206, structured data 1208, and an optimization algorithm 1210. The immersive virtual location database 1200 may be created and updated, for example, when a creator generates a new locations, adjusts an existing location, etc.

The virtual location identifier 1202 might be a unique alphanumeric label that is associated with an interactive, immersive experience. The creator identifier 1204 may show who created the location. The description 1206 might indicate that the location is associated with training, education, public speaking, etc. The structured data 1208 may comprise object information, location details, meshes, physics rules, story goals, rendering styles, etc. The optimization algorithm 1210 may reflect how an initial positioning of requested elements may be improved (e.g., via simulated annealing, Bayesian optimization, stochastic optimization, or any other optimization technique).

In this way, embodiments may be dynamic and adaptable (unlike prior solutions that are often hard-coded and inflexible). LLMs may be leveraged to create dynamic virtual environments based on descriptions (text or voice). This allows for a wide range of possibilities and adaptability to different scenarios, thereby enhancing the flexibility of the system. Furthermore, the natural language input makes it an ideal extension for AI assistants. Embodiments may also allow for the creation of virtual environments that are tailored to the specific requirements of the user. This is an improvement over pre-determined designs that may not fully meet a user's needs. By adjusting the initial generation description or defining subsequent changes, users can influence the design of the virtual environment, making it more relevant and immersive. Embodiments may automate the process of creating virtual environments, reducing the time and resources required as compared to traditional methods. In addition, embodiments use structured data (for example, in the JSON format) to represent the virtual environments, which can be easily shared among users. Embodiments may also provide enhanced immersion and realism by algorithmically optimizing object placement and ensuring adherence to common interior design principles. The generated environments are not only functionally accurate but also aesthetically pleasing. Embodiments may also provide efficiency and scalability. The combination of LLMs for generating structured data and algorithmic optimization ensures that the process is both efficient and scalable.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Any of the embodiments described herein may utilize LLM-powered agents, such as to provide an automated generation of cost functions and/or fine-tuning of optimization method-specific details (e.g., movement operators for a simulated annealing-based approach). As used herein, the phrase “LLM-powered agent” might refer to, for example, a system with complex reasoning capabilities, memory, and the means to execute tasks to reason through a problem, create a plan to solve the problem, execute the plan, etc. Such an approach may help shape the underlying behavior and rough stylistic direction of a framework. This may be important, for example, in connection with unique rooms that do not follow conventional interior design strategies. Furthermore, agents allow for the unsupervised gathering of stylistic details. For example, a creator could ask for “a modern, SAP-like CEO office” which would trigger an agent to do research on behalf of the creator as to what SAP offices look like, personal stylistic preferences of the current CEO, and amend the prompt with those stylistic details to create a more compelling result. Note that many different types of sources might be consulted by the agent. For example, company branding and slogans may seek to communicate messages through unconventional interior design strategies, such as integrating slogans like “run better together.” Agents could explore company slogans, for example, to inspire creative designs that convey these messages effectively. Other sources of inspiration might include advertisements, employee training materials, etc.

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of use cases, any of the embodiments described herein could be applied to other types of use cases.

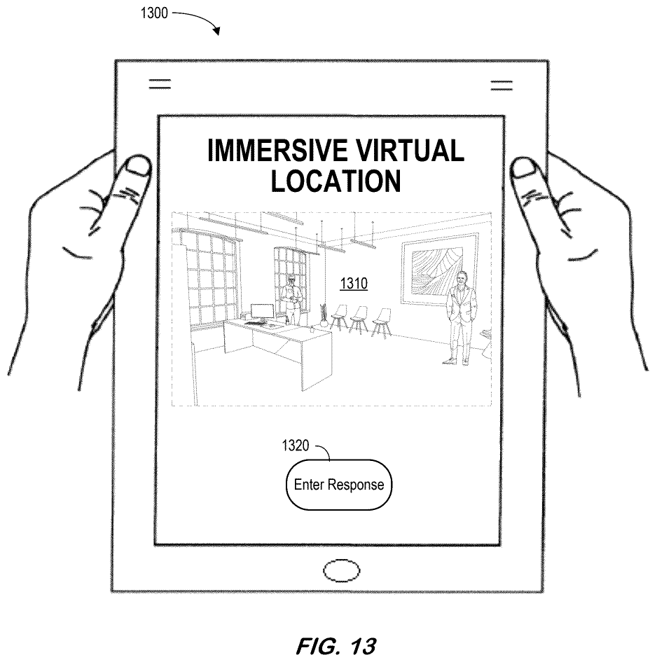

In addition, the displays shown herein are provided only as examples, and any other type of user interface could be implemented. For example, FIG. 13 illustrates a tablet computer 1300 providing an immersive virtual location display 1310 according to some embodiments. The immersive virtual location display 1310 might be used, for example, to train employees about new safety guidelines being implemented by an enterprise. A user may interact with the display 1310, such as by selecting an “Enter Response” text entry area 1320.

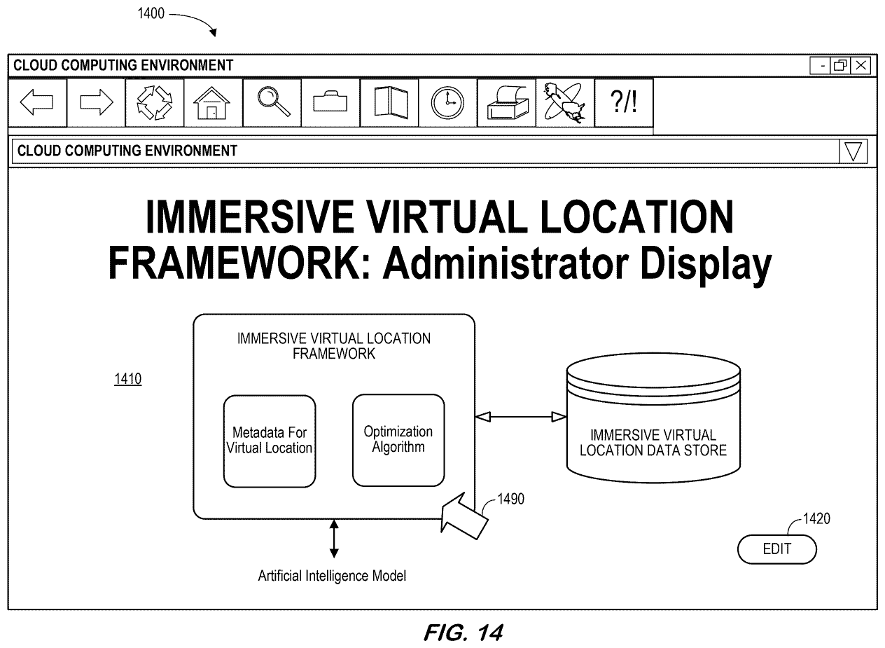

FIG. 14 is an operator or administrator display in accordance with some embodiments. The display 1400 includes a graphical representation 1410 of an immersive virtual location framework in accordance with any of the embodiments described herein. Selection of an element on the display 1400 (e.g., via a touchscreen or computer pointer 1490) may result in display of a pop-up window containing more detailed information about that element and/or various options (e.g., to define how an immersive virtual location framework interacts with various data stores, creator devices, external resources, etc.). Selection of an “Edit” icon 1420 may also let an operator or administrator adjust the operation of the system (e.g., to change mapping to a data store, adjust object or element properties, select optimization algorithms, etc.).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A system associated with an immersive virtual location framework, comprising:
a computer processor, and
a computer memory storing instructions that when executed by the computer processor cause the immersive virtual location framework to:
receive, from a creator, an immersive virtual location request,
automatically create a request prompt based on the immersive virtual location request,
transmit the request prompt to a generative artificial intelligence Large Language Model (“LLM”),
receive, from the LLM, structured data including metadata and information about the requested elements,
generate an initial immersive virtual location, and
execute an optimization algorithm, configured using cost functions and constraints based on the structured data, on the initial immersive virtual location, including positioning of requested elements within the initial immersive virtual location, to generate an optimized immersive virtual location.

2. The system of claim 1, wherein the immersive virtual location request includes a set of requested elements and relationships between the requested elements.

3. The system of claim 1, wherein the requested immersive virtual location includes at least one room.

4. The system of claim 3, wherein the requested elements comprise furniture within the room.

5. The system of claim 4, wherein the relationships between the requested elements comprises relationships between furniture within the room.

6. The system of claim 5, wherein the optimized immersive virtual location is a realistically furnished room in terms of at least one of: (i) functionality, (ii) aesthetics, (iii) positioning, and (iv) an interior design principle.

7. The system of claim 6, wherein the immersive virtual location request is associated with an enterprise and the optimized immersive virtual location is a realistically furnished room in terms of a design principle of the enterprise.

8. The system of claim 1, wherein the immersive virtual location framework is further to:
create a three-dimensional scene based on the optimized immersive virtual location,
store information about the three-dimensional scene in an immersive virtual location data store, and
arrange for a user to interact with the three-dimensional scene using a substantially real-time experience interaction engine.

9. The system of claim 1, wherein the optimization algorithm is associated with simulated annealing.

10. The system of claim 1, wherein the optimization algorithm is associated with a set of available optimization algorithms.

11. The system of claim 10, wherein the set of available optimization algorithms includes at least one of: (i) simulated annealing, (ii) multi-modal optimization, (iii) Bayesian optimization, (iv) robust optimization, (v) combinatorial optimization, (vi) stochastic optimization, and (vii) space mapping.

12. The system of claim 1, wherein the request prompt is based on at least one of: (i) an environment description of the virtual location, and (ii) information inferred from a scenario.

13. The system of claim 1, wherein the structured data is a Java Script Object Notation (“JSON”) file containing at least one of: (i) virtual environment locations, (ii) virtual environment dimensions, (iii) local or global constraints of objects, (iv) specific object properties, and (v) information that cannot be derived from an asset name.

14. The system of claim 1, wherein the immersive virtual location framework is associated with at least one of: (i) a personal soft skill training use case, (ii) a business skill use case, and (iii) an entertainment use case.

15. The system of claim 1, wherein the immersive virtual location framework dynamically refines the request prompt via interactions with the creator.

16. A computer-implemented method associated with an immersive virtual location framework, comprising:
receiving, by an immersive virtual location framework from a creator, an immersive virtual location request including a set of requested elements and relationships between the requested elements;
automatically creating a request prompt based on the immersive virtual location request;
transmitting the request prompt to a generative artificial intelligence Large Language Model (“LLM”);
receiving, from the LLM, structured data including metadata and information about the requested elements;
generating an initial immersive virtual location;
executing an optimization algorithm, configured using cost functions and constraints based on the structured data, on the initial immersive virtual location, including positioning of requested elements within the initial immersive virtual location, to generate an optimized immersive virtual location;
creating a three-dimensional scene based on the optimized immersive virtual location;
storing information about the three-dimensional scene in an immersive virtual location data store; and
arranging for a user to interact with the three-dimensional scene using a substantially real-time experience interaction engine.

17. The method of claim 16, wherein the requested immersive virtual location includes at least one room, the requested elements comprise furniture within the room, and the relationships between the requested elements comprises relationships between furniture within the room.

18. The method of claim 17, wherein the optimized immersive virtual location is a realistically furnished room in terms of at least one of: (i) functionality, (ii) aesthetics, (iii) positioning, and (iv) an interior design principle.

19. One or more non-transitory computer-readable media storing computer-executable instructions that, when executed by a computing system, cause the computing system to perform operations comprising:
receiving, by an immersive virtual location framework from a creator, an immersive virtual location request including a set of requested elements and relationships between the requested elements;
automatically creating a request prompt based on the immersive virtual location request;
transmitting the request prompt to a generative artificial intelligence Large Language Model (“LLM”);
receiving, from the LLM, structured data including metadata and information about the requested elements;
generating an initial immersive virtual location; and
executing an optimization algorithm, configured using cost functions and constraints based on the structured data, on the initial immersive virtual location, including positioning of requested elements within the initial immersive virtual location, to generate an optimized immersive virtual location.

20. The media of claim 19, wherein the optimization algorithm is associated with simulated annealing.

21. The media of claim 18, wherein the optimization algorithm is associated with a set of available optimization algorithms.
